(19) United States
(12) Patent Application Publication
(10) Pub. No.: US 2007/0002179 A1
(43) Pub. Date: Jan. 4, 2007

(54) Video display apparatus and video display method

(75) Inventor: Satoru Naka, Tsurugashima-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/476,788

(22) Filed: Jun. 29, 2006

(30) Foreign Application Priority Data
Jun. 30, 2005 (JP) 2005-193056

(51) Int. Cl. H04N 5/445; H04N 9/74

(52) U.S. Cl. 348/588; 348/738; 348/706; 348/564

(57) ABSTRACT

A video display apparatus comprises first receiving function for receiving first program and closed caption signal thereof and outputting video voice signal and closed caption signal, second receiving function for receiving second program and outputting video voice signal, speaker unit which receives voice signal and generates sound according thereto, display unit which receives video signal and displays video according thereto, and processing unit which receives the video voice signal and the closed caption signal, receives the video voice signal, forms video screen with the closed caption and outputs no voice signal for a video voice signal, forms a video screen and outputs a voice signal to the speaker for a video voice signal, and combines the two video screens to output them as one screen to the display unit.

### CROSS-REFERENCE TO RELATED APPLICATIONS

This application is based upon and claims the benefit of priority from Japanese Patent Application No. 2005-193056, filed Jun. 30, 2005, the entire contents of which are incorporated herein by reference.

### BACKGROUND

1. Field

One embodiment of the invention relates to a video display apparatus, and particularly to a video display apparatus and video display method for closed caption.

2. Description of the Related Art

In recent years, along with the popularization of digital technique, there have been increasingly developed and manufactured digital technique based products also in the field of imaging. Many additional functions have been known according to various specifications for, for example, television in the field of imaging.

Patent Document 1 (Jpn. Pat. Appln. KOKAI Publication No. 9-93548) describes that a form in which character and graphic information of an interpolating program or the like is displayed is devised in a television receiver with a character information function to simply display characters and graphic information transmitted in a data channel for audience.

Patent Document 2 (Jpn. Pat. Appln. KOKAI Publication No. 6-38130) and Patent Document 3 (Jpn. Pat. Appln. KOKAI Publication No. 7-59025) describe that, when performing 2-screen display using one television apparatus, one voice is reproduced from a speaker of the television apparatus and the other voice is reproduced from a headphone.

However, according to the watching/listening method shown in the prior art, there is a problem that when, performing 2-screen display using one television apparatus, one cannot understand the contents of several programs at the same time without listening one program's voice in a headphone or external device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an exemplary configuration of a video display apparatus according to one embodiment of the present invention;

FIG. 2 is a flowchart showing an exemplary processing of the video display apparatus according to one embodiment of the present invention;

FIG. 3 is an explanatory view showing one example of 2-screen display (voice: closed caption) of the video display apparatus according to one embodiment of the present invention;

FIG. 4 is an explanatory view showing one example of 4-screen display (voice: closed caption) of the video display apparatus according to one embodiment of the present invention;

FIG. 5 is an explanatory view showing one example of 2-screen display (voice+closed caption: closed caption) of the video display apparatus according to one embodiment of the present invention;

FIG. 6 is an explanatory view showing one example of 2-screen display (switching between voice and closed caption) of the video display apparatus according to one embodiment of the present invention;

FIG. 7 is an explanatory view showing one example of 2-screen display (voice: closed caption slide) of the video display apparatus according to one embodiment of the present invention;

FIG. 8 is an explanatory view showing one example of 2-screen display (voice: closed caption slide+entire slide) of the video display apparatus according to one embodiment of the present invention; and

FIG. 9 is an explanatory view showing one example of 2-screen display (voice: upward sliding of closed caption) of the video display apparatus according to one embodiment of the present invention.

### DETAILED DESCRIPTION

Various embodiments according to the invention will be described hereinafter with reference to the accompanying drawings. In general, according to one embodiment of the invention, a video display apparatus comprising: first tuner for receiving a first program and a closed caption signal thereof and outputting a video voice signal and a closed caption signal; second tuner for receiving a second program different from the first program and outputting a video voice signal; a speaker unit which receives a voice signal and generates sound according thereto; a display unit which receives a video signal and displays a video according thereto; and a processing unit which receives the video voice signal and the closed caption signal from the first tuner, receives the video voice signal from the second tuner, forms a video screen with the closed caption and outputs no voice signal for a video voice signal from the first tuner, forms a video screen and outputs a voice signal to the speaker for a video voice signal from the second tuner, and combines the two video screens to output them as one screen to the display unit.

One embodiment according to the present invention will be described below in detail with reference to the drawing.

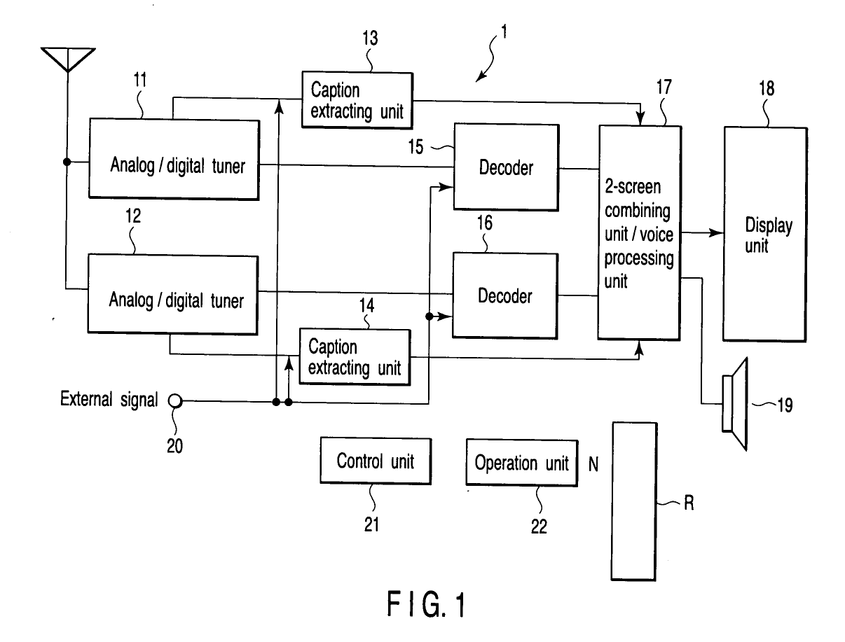

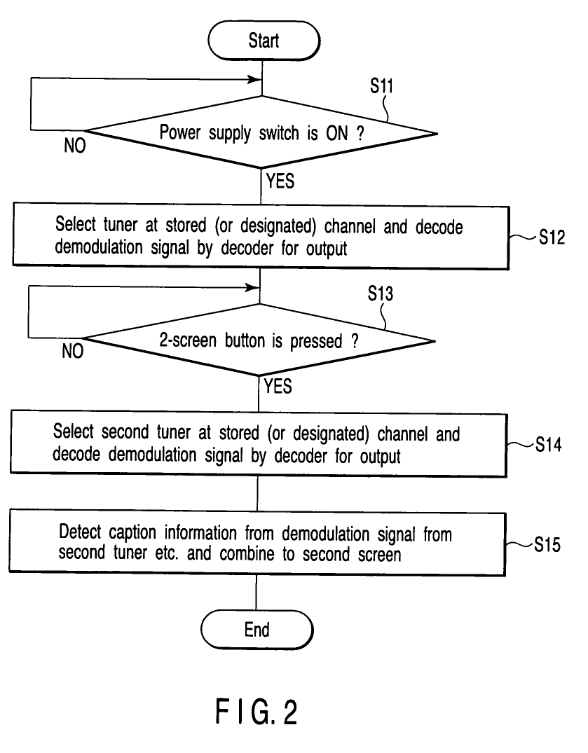

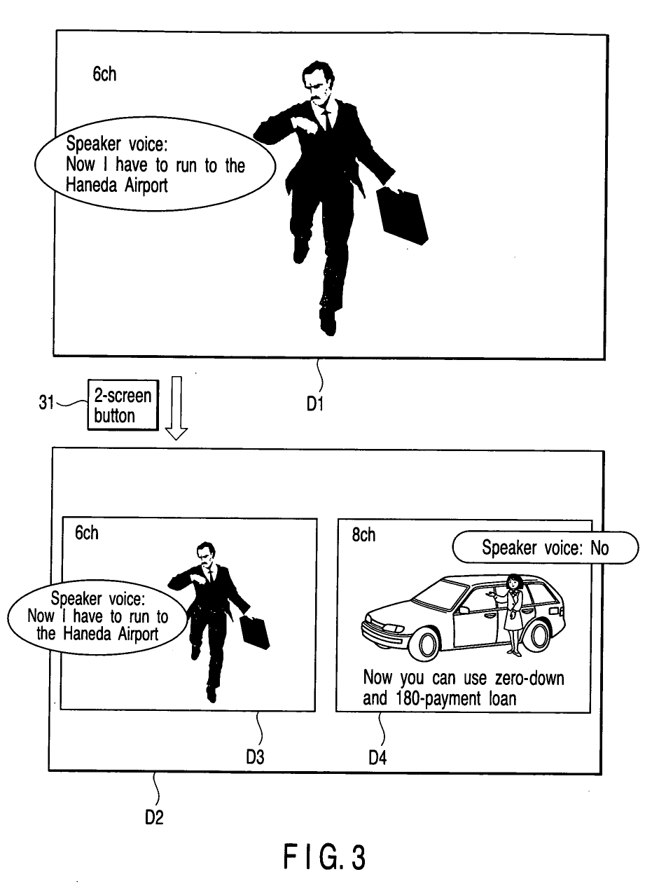

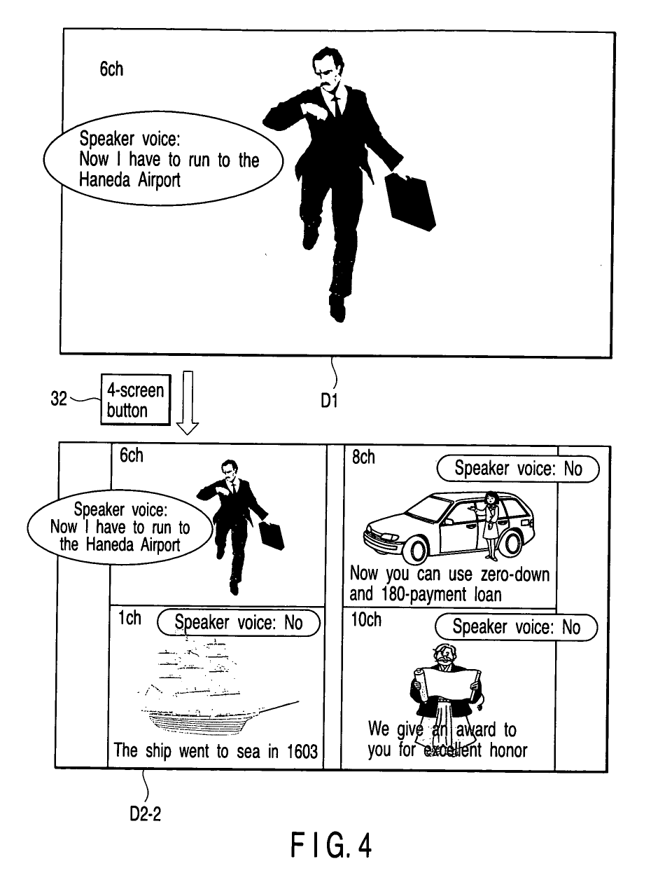

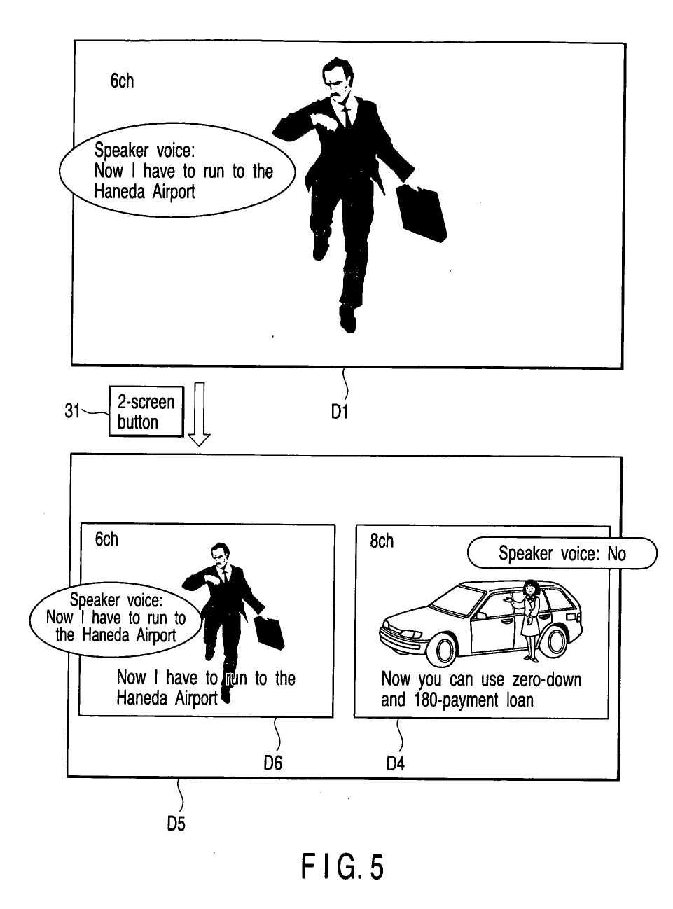

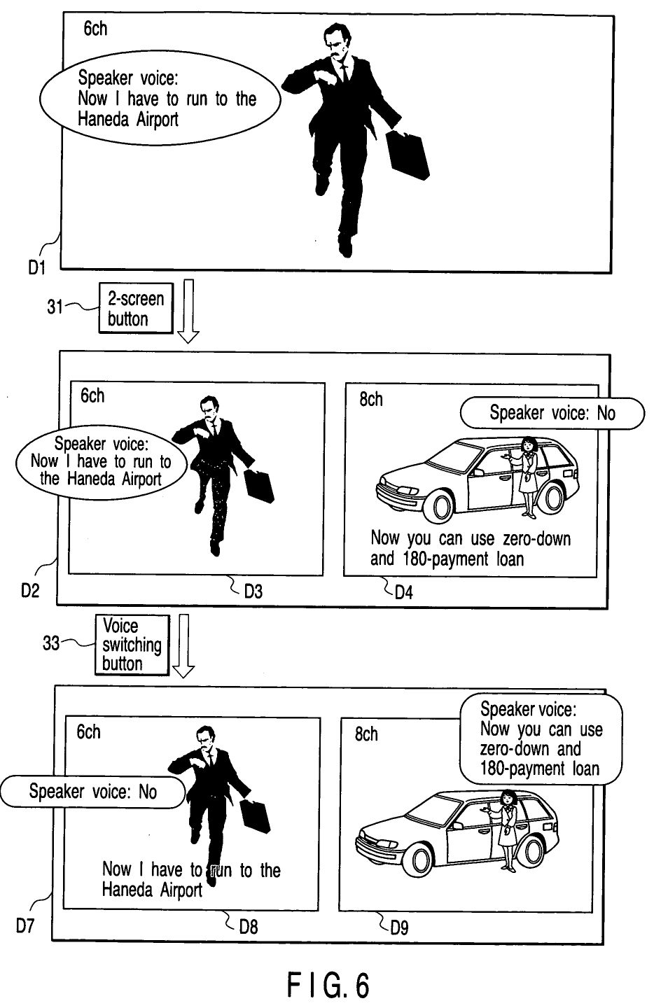

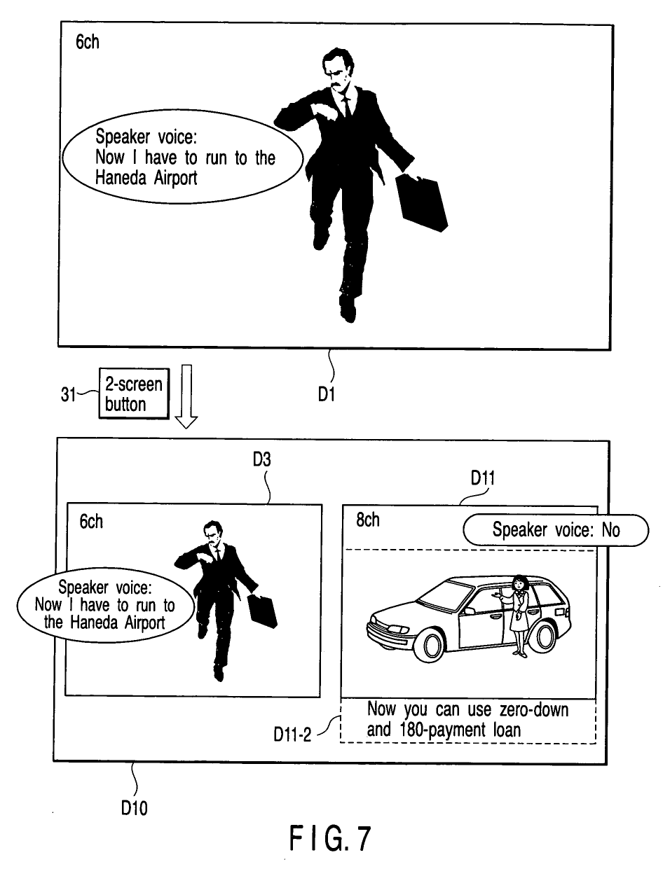

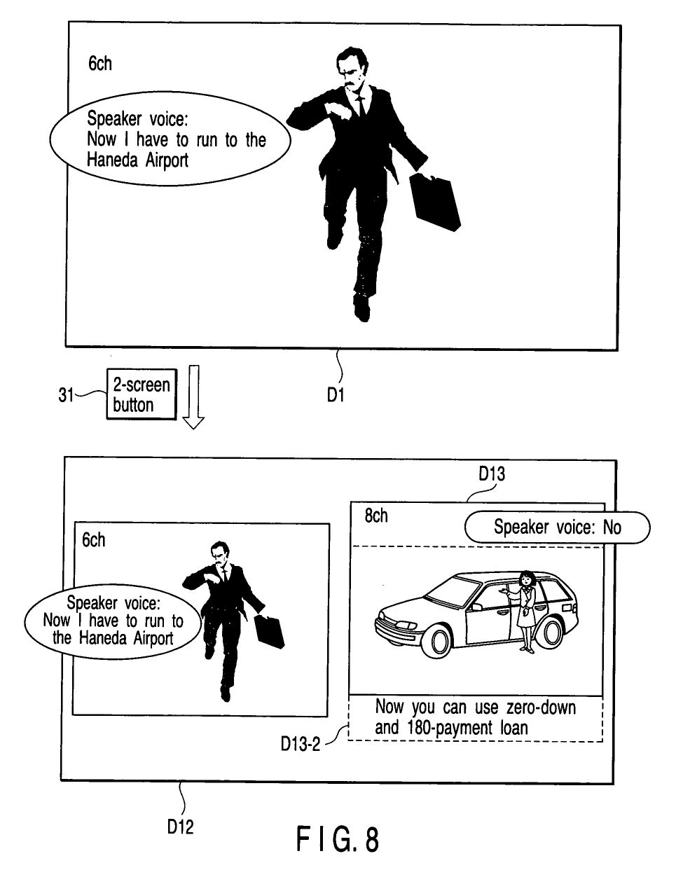

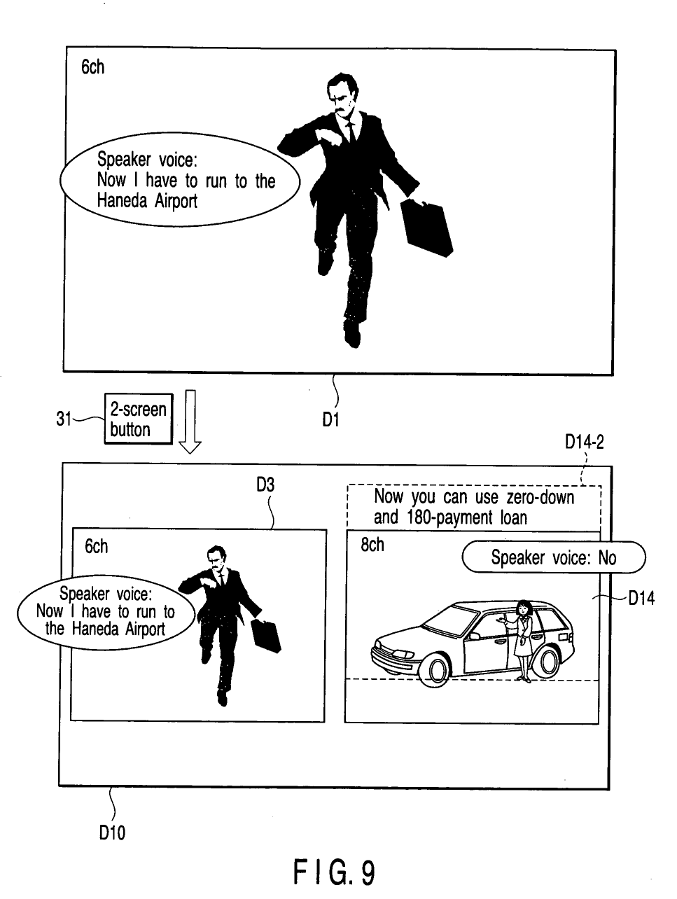

First, FIG. 1 is a block diagram showing an exemplary configuration of a video display apparatus according to one embodiment of the present invention. FIG. 2 is a flowchart showing an exemplary processing of the video display apparatus according to one embodiment of the present invention. FIG. 3 is an explanatory view showing one example of 2-screen display (voice: closed caption) of the video display apparatus according to one embodiment of the present invention. FIG. 4 is an explanatory view showing one example of 4-screen display (voice: closed caption) of the video display apparatus. FIG. 5 is an explanatory view showing one example of 2-screen display (voice+closed caption: closed caption) of the video display apparatus. FIG. 6 is an explanatory view showing one example of 2-screen display (switching between voice and closed caption). FIG. 7 is an explanatory view showing one example of 2-screen display (voice: closed caption slide). FIG. 8 is an explanatory view showing one example of 2-screen display (voice: closed caption slide+entire slide). FIG. 9 is an explanatory view showing one example of 2-screen display (voice: upward sliding of closed caption).

<Video Display Apparatus According to one Embodiment of the Present Invention>

A configuration of the video display apparatus according to one embodiment of the present invention will be first described with reference to FIG. 1.

In FIG. 1, the video display apparatus 1 comprises analog/digital tuners 11, 12 connected to an antenna unit, and caption extracting units 13, 14 for receiving demodulation signals as output signals from the tuners, respectively, to extract caption signals as closed caption signals. Further, the video display apparatus 1 comprises: decoders 15, 16 for receiving demodulation signals, respectively, to perform decode processing; a 2-screen combining unit/voice processing unit 17 for receiving the outputs from the caption extracting units 13, 14 and the outputs from the decoders 15, 16 to divide the same into a 2-screen combining image and a voice signal; a plane display unit 18 having an aspect ratio of 16:9 as one example; a speaker unit 19 incorporated in the main body; an input terminal 20 for fetching a video voice signal or caption signal (closed caption signal) from the outside; a control unit 21 for controlling the entire processing operation; and an operation unit 22 such as remote controller R or operation buttons on the front of the main body.

In the video display apparatus having the above configuration, the basic operation is performed as follows according to an operation of a remote controller (not shown) or the like in the operation unit 22. More specifically, when a power supply is turned ON through an audience's operation by a remote controller or the like, an operation of each configuration is controlled by the control unit 21, and a channel corresponding to a default value or a previously selected channel value stored in a memory is supplied to the analog/digital tuner 11. If the 1-screen mode has been set or the 1-screen mode is set as the default value, one analog/digital tuner 11 enters active, so that a broadcast signal from a broadcast station is synchronized according to the channel value given from a detection signal from the antenna unit.

The analog/digital tuners 11, 12 are for, at least, analog terrestrial broadcast, analog BS broadcast, digital terrestrial broadcast, digital BS broadcast, digital CS broadcast or the like, and are directed for selecting an arbitrary designated broadcast signal. A broadcast signal selected by the analog/digital tuner 11 is demodulated according to a type of the broadcast signal and is output to a succeeding stage as a demodulation signal. The demodulation signal is supplied to the decoder 15 to be subjected to, for example, MPEG decode processing, and is then supplied to the succeeding 2-screen combining unit/voice processing unit 17 as a reproducible video signal and voice signal. In the case of the normal 1-screen mode, the 2-screen combining unit/voice processing unit 17 supplies the supplied video signal to the display unit 18 and the voice signal to the speaker 19, respectively. Thus, it is possible to watch/listen the video and voice according to the broadcast selected by the analog/digital tuner 11.

<One Example of Watching/Listening Several Programs Utilizing Closed Caption>

An example of watching/listening several programs according to one embodiment of the present invention utilizing a closed caption display function will now be described in detail with reference to a flowchart and drawing.

First, in the flowchart of FIG. 2, when the power supply is turned ON through an audience's operation of the remote controller R or the like (S11), the analog/digital tuner 11 selects a specific broadcast signal according to a stored (or designated) channel value and demodulates the selected broadcast signal to output the demodulated signal to the succeeding decoder 15 (S12). The decoder 15 performs, for example, the MPEG decode processing on the demodulation signal and supplies it to the succeeding 2-screen combining unit/voice processing unit 17 as a reproducible video signal and voice signal. In the normal 1-screen mode, the 2-screen combining unit/voice processing unit 17 supplies the supplied video signal to the display unit 18 and the voice signal to the speaker 19, respectively. Consequently, it is possible to watch/listen the video and voice according to the broadcast selected by the analog/digital tuner 11, and the display screen as shown in the image display D1 of FIG. 3 is displayed on the display unit 18.

In FIGS. 3 to 7, characters circled in ellipse denote a comment indicating the presence of speaker voice, and characters in the other display screens D4, D2-2, D6 and the like denote a closed caption.

When a 2-screen button 31 of the remote controller R or the like is pressed in this state (step S13), the control unit 21 recognizes it to enter the 2-screen mode and selects the second analog/digital tuner 12 or the like based on the channel value stored in the memory (not shown) (or designated by the remote controller R or the like). The selected broadcast signal is demodulated and output to the succeeding stage (S14). The caption detecting unit 14 detects a caption signal (closed caption signal) from the demodulation signal and outputs it to the 2-screen combining unit/voice processing unit 17 (S15).

The 2-screen combining unit/voice processing unit 17 combines, according to the 2-screen mode of the control unit 21, a video voice signal from the first decoder 15 as the video signal selected by the first analog/digital tuner 11 and a video voice signal from the second decoder 16 as the video signal selected by the second analog/digital tuner 12 to produce a video signal for displaying the image display D2 of FIG. 3.

The image display D2 is a combined image of the image display D3 and the image display D4, and the image display D3 and the image display D4 each are an image compressed in the aspect ratio of 4:3. While the image display D3 is only compressed, the image display D4 is a superimposed image having the closed caption image of “now you can use zero-down and 180-payment loan” or the like from the caption extracting unit 14 superimposed thereon and having no voice, nevertheless an audience can understand the broadcast contents.

More specifically, the image display D3 corresponding to one video voice signal is permitted to output the voice signal to the speaker 19, and consequently, an audience can watch/listen the broadcast contents through the image and voice as usual. The image display D4 corresponding to the other video voice signal is not permitted to output the voice signal to the speaker 19, and instead the closed caption is displayed in the image display D4, so that the audience can understand the broadcast contents due to the video screen and closed caption image. As a result, the audience can watch/listen two broadcast programs: the image display D3 as usual and the image display D4 utilizing the closed caption image.

It is noted that if the audience calls the 2-screen by the 2-screen button 31 or the like, the closed caption is automatically displayed for the non-voice output broadcast without calling the setting screen for closed caption setting. Further, the closed caption display is not influenced by whether the normal closed caption display is ON or OFF in the setting screen set by the operation unit 22. Therefore, even when the closed caption display is OFF in the setting screen, the closed caption is automatically displayed at least on one screen by calling the 2-screen. Thus, it is possible to watch/listen several programs utilizing the closed caption with remarkable ease.

It is preferable to output the voice signal in the video voice signal by which the closed caption is displayed and which is not for speaker voice to an external terminal (not shown). In this case, it is possible that one person can watch/listen the video through speaker voice and the other person can watch/listen the video with the closed caption image through a headphone or the like.

(In the Case of more Than Four Screens)

According to the embodiment of the present invention, the simultaneous display with closed caption is possible not only in the case of the 2-screen described above but also in the case of 3-screen or more for the video voice for 4 programs as shown in FIG. 4, for example. In this case, it is preferable to acquire the video voice signals for the four programs and to produce the combined screen D2-2 by newly providing four analog/digital tuners 11, 12 as shown in FIG. 1.

Even in the case of the two analog/digital tuners 11, 12 as shown in FIG. 1, it is preferable that one tuner 11 keeps on selecting the program of “6ch” and the other tuner 12 performs time division processing through the control by the control unit 21 or the like to select and display “8ch”, “1ch” and “10ch”. In this case, even if the broadcast station is intermittently selected, one can roughly understand the program contents due to the closed caption and intermittent video.

It is preferable that the program “6ch” for voice listening is displayed on the left half of the screen and the remaining “8ch”, “1ch” and “10ch” are displayed on the right half of the screen in vertical division. In this manner, preferably one can keep on mainly watching/listening the “6ch” on the left half of the screen (or more than 50% thereof) while checking other programs “8ch”, “1ch” and “10ch” on the remaining screen.

(Simultaneous use of Voice and Closed Caption)

Next, it is preferable to simultaneously use the speaker voice output and the closed caption as in the image display D5 shown in FIG. 5. More specifically, in this case, the closed caption is displayed on both the image display D6 and the image display D4, and such several closed caption displays are possible under control of the control unit 21 through the audience's setting via the operation unit 22. In this case, secure watching/listening is possible from both the speaker voice and the closed caption in the image display D6, which is preferable.

(Switching of Voice Output Programs)

As shown in FIG. 6, the switching of voice output programs is easily performed based on an operation signal by the operation unit 22 from the voice switching button 33 on the remote controller R or the like. Mode specifically, when the control unit 21 recognizes the operation signal from the voice switching button 33 or the like, it supplies the control signal to the 2-screen combining unit/voice processing nit 17 to instruct the switching of the two video voice signals. Thus, the 2-screen combining unit/voice processing unit 17 preferably sets the video voice signal of “6ch” as with no speaker voice and with closed caption, and the video voice signal of “8ch” as with speaker voice and with no closed caption. Thereby, a user can easily switch program which he/she mainly watches/listens.

(Change in Closed Caption Display Position)

As shown in FIG. 7, it is preferable to change the closed caption display position by calling the closed caption position change screen through the operation of the operation unit 22 of the remote controller R or the like. More specifically, when a combined screen made of several 4:3 screens is formed on the combined screen D10, upper and lower areas of the screen are unused, and the closed caption is moved to be displayed on the unused area, so that advantageously the closed caption can be securely displayed and the image itself can be displayed separately from the closed caption. The display position of the closed caption signal for the closed caption screen display D11-2 is changed in the 2-screen combining unit 17 with respect to the screen display D11 corresponding to the video signal according to the control by the control unit 21. Thus, as shown in FIG. 7, it is possible to slide the closed caption screen display D11-2 downward, thereby separating the displays of the program video and the closed caption image.

As shown in FIG. 8, it is preferable to call the position change screen and to change the positions of both the program video and the closed caption image by the operation of the operation unit 22 of the remote controller R or the like. In other words, the screen display D13 and the closed caption screen display D13-2 are simultaneously moved, for example, upward (in the vertical direction). This makes it possible for the program video and the closed caption image to be rearranged at the center of the screen, thereby providing an easily viewable screen for the audience.

(Automatic Position Moving Processing of Closed Caption)

Further, it is preferable that a position of the closed caption on the video screen is detected and the position of the closed caption is determined through the processing by the control unit 21 and the 2-screeen combining unit 17, etc., so that the closed caption image is automatically slid and displayed on the upper unused area of the video screen or the lower unused area thereof according to the position.

More specifically, in the case where the closed caption is positioned lower than the center of the video image when the video image and the closed caption are displayed for one video voice signal, the position of the closed caption image is changed such that the closed caption is displayed in the screen of the display unit and outside the video screen downward, thereby producing a combined image. In the case where the closed caption is positioned upper than the video image, the position of the closed caption image (closed caption image D14-2 in FIG. 9) is preferably changed such that the closed caption is displayed outside the video image upward, thereby producing a combined image (combined image D14 in FIG. 9). Thus, the audience can watch/listen the combined image with the optimum closed caption position without any special operation.

(Other Closed Caption Setting Processing)

It is preferable that the closed caption image is appropriately changed in its display specification by calling the setting screen through the operation of the operation unit 22 of the remote controller R or the like, for example. More specifically, when displaying the video image and the closed caption, the set character size, character color or character characteristics can be arbitrarily selected. In the control unit 21 and the 2-screen combining unit 17, the closed caption image is produced based on the character size, character color or character characteristics to be combined with the video signal, thereby producing a combined image.

Those skilled in the art can realize the present invention based on various embodiments described above, and further can easily devise various modifications to these embodiments to be applied to various embodiments without inventive ability. Therefore, the present invention covers a wide range as far as it is consistent with the disclosed principle and novel characteristics, and is not limited to the above embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display apparatus comprising:
first tuner for receiving a first program and a closed caption signal thereof and outputting a video voice signal and a closed caption signal;
second tuner for receiving a second program different from the first program and outputting a video voice signal;
a speaker unit which receives a voice signal and generates sound according thereto;
a display unit which receives a video signal and displays a video according thereto; and
a processing unit which receives the video voice signal and the closed caption signal from the first tuner, receives the video voice signal from the second tuner, forms a video screen with the closed caption and outputs no voice signal for a video voice signal from the first tuner, forms a video screen and outputs a voice signal to the speaker for a video voice signal from the second tuner, and combines the two video screens to output them as one screen to the display unit.

2. A video display apparatus according to claim 1, wherein the processing unit outputs a voice signal from the first tuner for displaying the closed caption to an output terminal.

3. A video display apparatus according to claim 1, wherein the processing unit displays a video screen and a closed caption and outputs a voice signal for a video voice signal from the first tuner, and further receives a closed caption signal to display a video screen and a closed caption and outputs no voice signal for the second tuner.

4. A video display apparatus according to claim 3, wherein the processing unit switches the video voice signal by which a closed caption is not displayed and a voice signal is output and the video voice signal by which a closed caption is displayed and a voice signal is not output according to an operation signal.

5. A video display apparatus according to claim 1, wherein the processing unit changes a closed caption display position such that only the closed caption is displayed in the screen of the display unit and outside the video screen when displaying the video screen and the closed caption.

6. A video display apparatus according to claim 1, wherein the processing unit equally changes the display positions of the video screen and the closed caption in the vertical direction.

7. A video display apparatus according to claim 1, wherein, in the case where the closed caption is positioned lower than the center of the video screen when displaying the video screen and the closed caption, the processing unit changes the closed caption display position such that the closed caption is displayed in the screen of the display unit and outside the video screen downward, and in the case where the closed caption is positioned upper than the center of the video screen, the processing unit changes the closed caption display position such that the closed caption is displayed outside the video screen upward.

8. A video display apparatus according to claim 1, wherein, when displaying the video screen and the closed caption, the processing unit processes a closed caption signal in order to display a closed caption according to a set character size, character color or character characteristics.

9. A video display apparatus according to claim 1, wherein, when displaying the video screen and the closed caption, the processing unit processes the closed caption signal in order to display the closed caption at a set position.

10. A video display method comprising:
receiving a first program and a closed caption signal thereof and outputting a video voice signal and a closed caption signal;
receiving a second program different from the first program and outputting a video voice signal; and
forming a video screen with the closed caption and outputting no voice signal for a video voice signal of the first program, forming a video screen and outputting a voice signal to a speaker for a video voice signal of the second program, and combining the two video screens to display them as one screen.
